(19) United States
(12) Patent Application Publication
(10) Pub. No.: US 2003/0110695 A1
(43) Pub. Date: Jun. 19, 2003

(54) Revolving door

(76) Inventor: Rene Cornelis Nat, Purmerend (NL)

Correspondence Address: PEACOCK MYERS AND ADAMS P C, P O BOX 26927, ALBUQUERQUE, NM, 871256927

(21) Appl. No.: 10/300,998

(22) Filed: Nov. 21, 2002

Related U.S. Application Data
(63) Continuation of application No. PCT/NL01/00387, filed on May 21, 2001.

(30) Foreign Application Priority Data
May 24, 2000 (NL) 1015281

(51) Int. Cl. E06B 3/34

(52) U.S. Cl. 49/41

(57) ABSTRACT

The invention relates to a revolving door suitable for installation in a wall of a building, comprising a shell with an entrance opening and an exit opening, and inside the shell rotatably positioned door leaves, the shell and/or the door leaves being constructed from at least metal structural members, in particular comprising aluminum extruded sections and aluminum plate elements. On the visible side at least the extruded sections are provided with a covering material.

The invention relates to a revolving door suitable for installation in a wall of a building, comprising a shell with an entrance opening and an exit opening, and inside the shell rotatably positioned door leaves, the shell and/or the door leaves being constructed from at least metal structural members provided with a covering material.

Such a revolving door is generally known and has been marketed by Eastern Door Service Inc. and manufactured by Horton Automatics of Corpus Cristi; Tex., USA; see internet page http://www.edsdoors.com/spec9500, revision Dec. 30, 1999. Such a revolving door has also been marketed in the previous century and thereafter by applicants, for example, under the name of Tournex. Tournex is a registered trademark held by applicants.

U.S. Pat. No. 4,980,992 discloses a revolving door that is suitable for installation in a wall of a building comprising a shell with an entrance opening and an exit opening and inside the shell rotatably positioned door leaves whereby the shell and/or the door leaves are constructed from at least metal structural members.

WO 97/25509 discloses a revolving door suitable for installation in a wall of a building comprising a shell with an entrance opening and an exit opening whereby inside the shell there are rotatably positioned door leaves and which door is provided with a canopy which comprises at least one substantially circular canopy strip.

The production time of the known revolving door is approximately 200 hours. This production time is needed among other things, for repairing surface defects which produce an aesthetically unattractive appearance. To do this the prior art method involves, among other things, a rather labour-intensive muffle treatment. Additionally, this muffling or powder coating makes the respective construction components resistant to corrosion resulting from various weather influences. A further disadvantage of the known revolving door is that even though it is made of aluminium, it is still a rather heavy construction. Another disadvantage of the known revolving door is that it is not readily adapted to deviating building-in dimensions, especially with respect to the height that the whole revolving door construction is to have.

The object of the invention is to improve one or more of these aspects. In a first desirable embodiment therefore, the revolving door is characterized in that the metal structural members, in particular comprise aluminium extruded sections and aluminium plate elements, whereby on the visible side at least the extruded sections are provided with the covering material such that the covering material is sunk into a recess provided in the extruded sections. From an aesthetic point of view this is preferred as it gives the finished revolving door a neat and smoothly finished appearance.

Based on the same inventive idea, the revolving door having a canopy comprising among other things, a ceiling and at least one substantially circular canopy strip is characterized in that the canopy strip is fixed by means of one or several clamping sections, and in that a covering material is mounted on the canopy strip or strips such that the covering material is sunk into a recess provided in the canopy strip or canopy strips.

Both embodiments differ from the revolving door of the prior art through the redundancy of a conventional finishing treatment by means of, for example, powder coating in order to remove the surface defects. Such surface problems are literally made invisible by the covering material; it is of course expedient for the covering material to have the desirable visual quality. One thing and another may be simply carried out by affixing the covering material on the extruded sections or the canopy strip by means of adhesion.

In a further aspect of the invention, a very convenient embodiment of the revolving door is characterized in that a first canopy strip is provided, and at a predetermined distance above the first canopy strip a second canopy strip, with the covering material being affixed to both the first and the second canopy strip. This embodiment features the possibility of a lighter canopy construction due to the fact that the covering material may be very thin, while visually giving the impression of having over the entire height the thickness that is usual for a canopy strip. An additional advantage is that this construction allows the height of the canopy to be adjusted in accordance with the local conditions. This greatly increases the building-in possibilities of the revolving door according to the invention.

A special aspect of the invention is further that it provides the possibility of using different materials for the covering material and the sections or canopy strips, respectively, to which this covering material is applied. It may the particularly desirable for the extruded sections or canopy strips and the material applied thereon to have different colour combinations. This is an elegant and simple manner of providing the revolving door according to the invention with an appearance that optimally matches the colour scheme of the building in which it is installed. To this end the inventor proposes the use of plastic, but observes that the use of covering material in the form of a metal, for example aluminium, is also possible.

The invention will now be further elucidated with reference to the drawing which

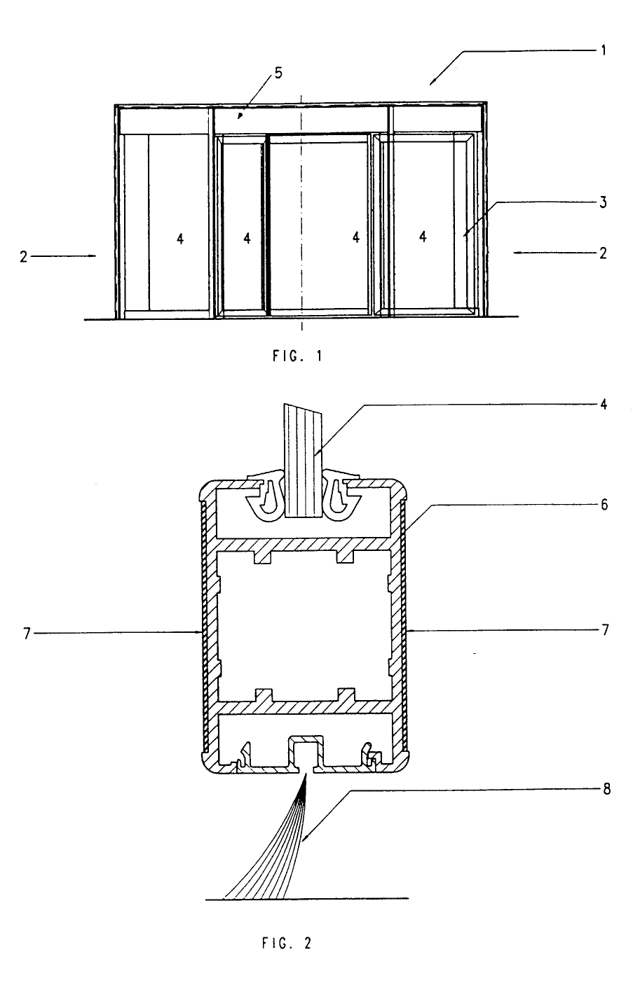

in FIG. 1, shows the revolving door according to the invention;

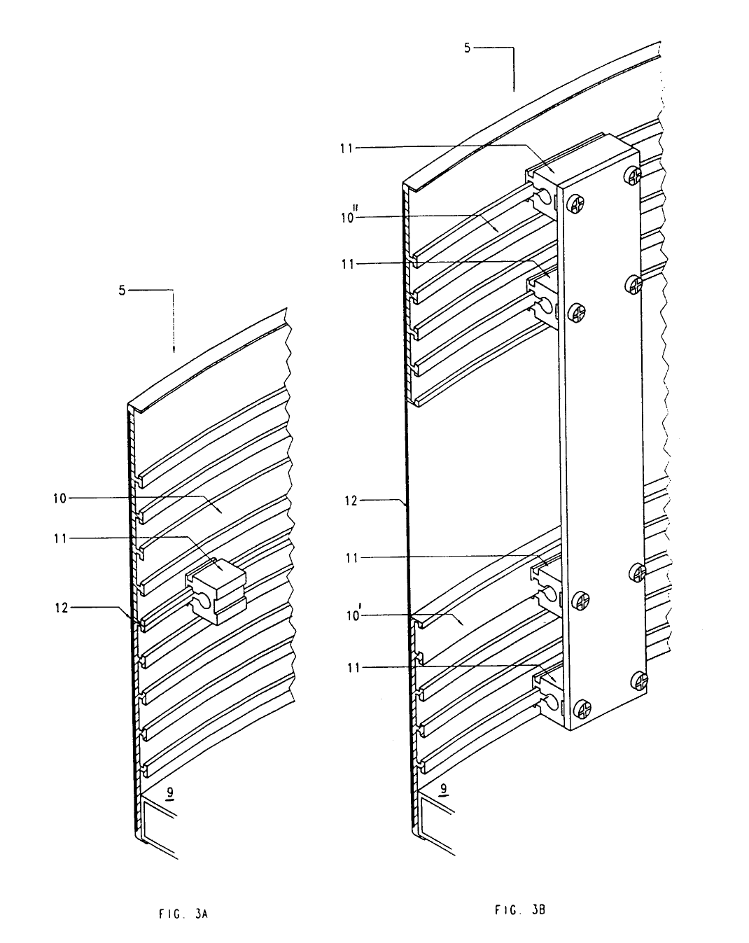

in FIG. 2, shows a door section of a revolving door according to the invention; and

in FIG. 3, shows a portion of the canopy construction of the revolving door according to the invention.

Similar components in the Figures are identified by the same reference numbers.

With reference first to FIG. 1, a front view of a revolving door 1 according to the invention is shown, which is installed in a wall 2 of a building. Such a revolving door 1 has curved panels 3 forming a shell. In a manner well known to the person skilled in the art, the shell 3 is provided with an entry opening and opposite to the entry opening, an exit opening, the rotatable door leaves mounted in the shell 3 separating the entry opening from the exit opening. In a manner completely known to the person skilled in the art, the shell 3 and/or the door leaves are constructed with metal construction components usually made of aluminium, and the shell and also the door leaves are provided with glass panels 4. At its topside, the revolving door 1 is further provided with a canopy 5. At the inside of the revolving door 1, this canopy 5 is embodied with a ceiling beneath which the door leaves are able to rotate.

With further reference now to FIG. 2, a cross section of an extruded section of a revolving door according to the invention is shown, the respective extruded section being a door section 6. It should be noted, however, that the explanation of the invention given herein is naturally not limited to this specific example, but rather that this invention may also be applied to other sections that form part of the construction of the revolving door 1 according to the invention. In accordance with the invention, the door section 6 is provided with a covering material 7 affixed to the door section at the visible side. The Figure further shows that the door section 6 holds a glass panel 4, and at the side directed toward the shell, a fan 8 to ensure the draft-proof abutment of the respective door leaf to the shell of the revolving doors. The above mentioned covering material 7 is preferably stuck onto the door section 6 in a manner such as to inlay the covering material 7 into a recess provided in the door sections 6. This is clearly shown in the Figure.

In a particular aspect of the invention, the door section 6, and the covering material 7 are embodied in different colours, or different materials are used. Usually the door section 6 is made of aluminium. The covering material 7 may, for example, be a plastic or it may be metal, in which case it is preferably aluminium.

With further reference to FIG. 3A, a portion of the interior of the canopy 5 of the revolving door 1 according to the invention is shown. Similarly, FIG. 3B also shows a portion of the interior of a canopy of a revolving door according to the invention. The difference between the embodiment of FIG. 3B and that of FIG. 3A will be elucidated below. The canopy 5 comprises a ceiling part 9 and abutting thereto a canopy strip 10. Said canopy strip 10 is substantially circular to correspond with the construction of the shell 3 of the revolving door 1 according to the invention. At its inside, the canopy strip 10 is provided with a plurality of profile sections with which canopy strip clamping sections 11 are able to engage, which serve to fix the canopy strip 10. In accordance with the invention, the visible side of the canopy strip 10 is provided with a covering material 12. In a particular aspect of the invention, the canopy 5 is embodied with a first canopy strip 10′ (see FIG. 3B), and a second canopy strip 10″ located at a predetermined distance above the first canopy strip 10′, the covering material 12 being affixed to both the first and the second canopy strip 10′, 10″, preferably by means of adhesion. To this end the canopy strips 10′ and 10″ preferably comprise a recess for inlaying the covering material 12. It is also conceivable for the canopy strips 10′ and 10″ to have different colours. The covering material 12 may be plastic or may be generally made of a different material to that of the canopy strips 10′, 10″, which are usually made of aluminium. However, within the framework of the invention, the covering material 12 also is preferably made from aluminium. This usually produces the fewest constructive problems and optimal aesthetic results with regard to the finished revolving door.

What is claimed is:

1. A revolving door suitable for installation in a wall of a building, comprising a shell with an entrance opening and an exit opening, and inside the shell rotatably positioned door leaves, the shell and/or the door leaves being constructed from at least metal structural members provided with a covering material, wherein the metal structural members comprise aluminum extruded sections and aluminum plate elements, wherein on the visible side at least the extruded sections are provided with the covering material, and wherein the covering material is sunk into a recess provided in the extruded sections.

2. A revolving door according to claim 1, wherein the extruded sections and the covering material have different color combinations.

3. A revolving door according to claim 1, wherein the covering material is plastic.

4. A revolving door suitable for installation in a wall of a building, comprising a shell with an entrance opening and an exit opening, and inside the shell rotatably positioned door leaves, the shell and/or the door leaves being constructed from at least metal structural members, comprising aluminum extruded sections and aluminum plate elements, and a canopy comprising a ceiling and at least one substantially circular canopy strip, wherein the canopy strip is fixed by means of one or several clamping sections, and in that a covering material is mounted on the canopy strip or strips, whereby the canopy strip or canopy strips comprise a recess for inlaying the covering material.

5. A revolving door according to claim 4, wherein a first canopy strip is provided, and at a predetermined distance above the first canopy strip a second canopy strip is provided, with the covering material being affixed to both the first and the second canopy strip.

6. A revolving door according to claim 4, wherein the covering material is affixed to the canopy strip or canopy strips by means of adhesion.

7. A revolving door according to claim 4, wherein the canopy strip or canopy strips and the covering material have different colors.

8. A revolving door according to claim 4, wherein the covering material is metal.

9. A revolving door according to claim 8, wherein the covering material is aluminum.
